(19) United States
(12) Patent Application Publication
(10) Pub. No.: US 2015/0113093 A1
(43) Pub. Date: Apr. 23, 2015

(54) APPLICATION-AWARE BROWSER

(71) Applicants: FRANK BRUNSWIG, Heidelberg (DE); Alexander Lingg, Walldorf (DE); Hans-Juergen Richstein, Rauenberg (DE); Ramandeep Sethi, Walldorf (DE); Stanley Stadelman, Walldorf (DE)

(72) Inventors: FRANK BRUNSWIG, Heidelberg (DE); Alexander Lingg, Walldorf (DE); Hans-Juergen Richstein, Rauenberg (DE); Ramandeep Sethi, Walldorf (DE); Stanley Stadelman, Walldorf (DE)

(21) Appl. No.: 14/059,344

(22) Filed: Oct. 21, 2013

(51) Int. Cl. H04L 29/08

(52) U.S. Cl. CPC H04L 67/2842
USPC 709/216

(57) ABSTRACT

Methods and apparatus, including computer program products, are provided for an application-specific browser. In some implementations, a method may be provided which includes retrieving, by a browser, content of a resource; determining, based on an identity of the resource, whether to store the content in a persistent cache; and storing the content in the persistent cache, when the identity indicates storage to persistent cache is enabled for the content of the resource.

### FIELD

The present disclosure generally relates to browsers.

### BACKGROUND

Today, the web browser has become an essential part of interacting with the Internet, web services, applications, and the like. The web browser, also referred to as a browser, is a software application configured to access information on the Internet. Examples of browsers include Internet Explorer, Opera, and the like. The browser typically returns a page or other content at a given address on the Internet, and then presents the page or content on the browser, where a user can interact with that page or content. Browsers can be used in mobile devices, such as smartphones, tablets, and the like, and can be used in private or proprietary systems, such as a specialized business system.

### SUMMARY

Methods and apparatus, including computer program products, are provided for an application-aware browser configured to cache content in an application-specific way.

In some implementations, a method may be provided which includes retrieving, by a browser, content of a resource; determining, based on an identity of the resource, whether to store the content in a persistent cache; and storing the content in the persistent cache, when the identity indicates storage to persistent cache is enabled for the content of the resource.

In some implementations, the above-noted aspects may further include additional features described herein including one or more of the following.

The content may be stored in a non-persistent cache, when the identity indicates storage to persistent cache is not enabled for the content of the resource. The browser may include a plugin configured to perform at least the determining and the storing. The plugin may include script configured in accordance Apache Cordova. The plugin may be native to the browser. The resource may include at least one of the following: a plugin, an application, a hypertext markup language file, a cascading style sheet, a script, a JavaScript, a JavaScript Object Notation, and an image. Metadata may be accessed. The accessed metadata may be indicative of whether storage to persistent cache is enabled for the content of the resource. The metadata may include at least one of the identity of the resource, an address of the resource, and a uniform resource locator of the resource. The content may be stored, based on the accessed metadata, in the persistent cache, when the metadata indicates storage to persistent cache is enabled for the content. The metadata may include a list of one or more resources. An indication may be received from at least one of the plugin and a web server. The indication may indicate that storage to persistent cache is enabled for the content. The content may be stored, based on the received indication, in the persistent cache, when the received indication indicates storage to persistent cache is enabled for the content.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an example of a system including an application-aware browser, in accordance with some example implementations;

FIG. 2 depicts an example of a full screen view including an attachment window, in accordance with some example implementations;

FIG. 3 depicts another example of a system including an application-aware browser, in accordance with some example implementations; and

FIG. 4 depicts an example of a process for an application-aware browser, in accordance with some example implementations.

Like labels are used to refer to same or similar items in the drawings.

### DETAILED DESCRIPTION

The startup time of an application is a factor in a user's experience with the application. For example, a relatively slow startup time may lead to a relatively poor user experience, when compared to a quicker startup time. The startup time for a browser may be a function of the time it takes to load the browser application, which may include loading dozens of related resources, including plugins, content, web content, hypertext markup language (HTML) files, cascading style sheets (CSS), scripts (for example, JavaScript and the like), JavaScript Object Notation (JSON), images, fonts, and the like. In a local area network or other types of wired networks, the latency associated with downloading these resources may be tolerable (LAN) as latency times may be about a 10 milliseconds to about 20 milliseconds.

However, in a wireless network (for example, EDGE, 3G, and the like) including user equipment such as smartphones, tablets, and the like, the latency associated with downloading these resources may be unacceptable to some users as latencies may be well above about 700 milliseconds for a single resource. This 700 milliseconds is a product of the number of resources needed for a given web application divided by the number of maximal parallel requests (MPR) of the browser. For example, a web application having 50 resource files loading with a browser having 5 MPRs in for example an EDGE wireless access network would have about 10 seconds of just latency time (for example, where data is not delivered or presented to a user during that timeframe). While there are generic caching capabilities in place for some mobile browsers, these browsers are geared to optimize resource allocation and/or hardware performance, rather than the user experience with respect to specific applications. To avoid changing flash memory too often (anticipating that an end-user may browse to an undetermined large range of web resources during the device lifespan), data may be cached in-program memory only in some of these browsers, and the data may not exceed the lifetime of the browser session. If an operating system-controlled resource threshold is reached, cached data or resources may be purged arbitrarily and without prejudice. The generic caching capabilities available in the browser may prescribe recommended cache validity timeframes for specific resources (for example, cache headers), but these values may be ignored by the browser application and/or operating system, and the resources purged without notice. Therefore, an application provider cannot confidently rely on the persistence and existence of the application's resources within the browser cache at any given moment.

The subject matter disclosed herein may provide, in some example implementations, an application-aware browser. This application-aware browser may cache in persistent memory at the wireless user equipment an application and/or its related resources. This caching may be performed in an application-specific way, so that some applications and their related resource may be cached, but other may not be cached. However, those that are cached may, in some example implementations, result in lower latencies, when compared to getting resources from a web server during startup.

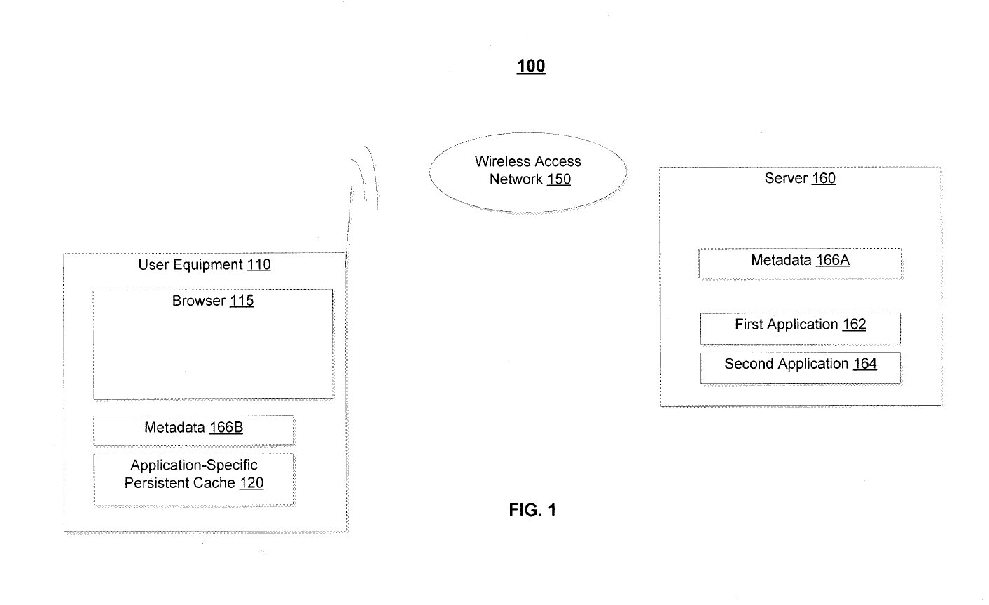

FIG. 1 depicts a system 100 including user equipment 110, such as a smartphone, a tablet, and/or any other device. The user equipment 110 may further include an application-aware browser 115 configured to cache certain applications or resources, including content, for the application in memory, such as application-specific persistent cache 120, to reduce the latency associated with loading or re-loading resources, such as web content, a plugin, and the like, at browser 115.

User equipment 110 may couple to a wireless access network 150 and server 160, where applications 162 and 164 or resources for those application may be made available or stored. The wireless access network 150 may be implemented as a public land mobile network, a wireless local area network, and/or any other wireless network. User equipment 110 may couple to server 160 via one or more other nodes including base stations, wireless access points, and the like. The server 160 may be implemented as a web server addressable via a domain name, uniform resource locator (URL), and the like.

The application-aware browser 115 may download application 162 and/or one or more resources for application 162, and store, in application-specific persistent cache 120, application 162 and/or related resources. The application-specific cache 120 is persistent in the sense that it either keeps content between browser sessions or keeps the content when power is removed from the user equipment 110 or application-specific cache 120.

In some example implementations, the decision by application-aware browser 115 to cache application 162 and/or its related resources is performed based on metadata and/or signaled by the application itself.

In some example implementations, metadata 166A associated with application 162 and its resources may indicate to application-aware browser 115 to store application 162 and/or its resource(s) in persistent cache 120. The metadata may also indicate that application 164 and/or its resources should not be stored in persistent cache 120. The metadata 166A may be stored at server 160 and accessed by application-aware browser to determine whether to cache a given application and/or its related resources. The metadata may also indicate how often the application 162 and/or its resource(s) stored in persistent cache 120 should be refreshed. In some example implementations, the metadata may include a list of all of the applications and/or resources that are cached in persistent cache 120. In some example implementations, root resources, such as index.html, may not be cached to ensure re-authentication if the server requires it. For example, a security session token may be valid for a certain time, such as 24 hours, after which the server will force a re-authentication.

In some example implementations, application 162 may signal to the application-aware browser 115 what applications/resources should be stored in persistent cache 120. For example, application 162 may include an indication which signals user equipment 110 and/or application-aware browser 115 to store application 162 and/or its related resources in persistent cache 120. The application-aware browser 115 may check each individual application used at browser 115 to determine whether the application and/or its resources are to be stored in application-specific persistent cache 120. In this sense, the browser 115 is aware of which application it is allowed to execute out of persistent cache 120. Those executed out of application-specific persistent cache 120 may, in some implementations, have quicker startup times and lower latencies, when compared to a get from server 160.

The caching in an application-specific way may enable the application-aware browser 115 to have the right version of a specific application or related resources, such as web content and the like, available on user equipment 110 in persistent cache 120. Moreover, the use of an application-specific strategy is consistent with the storage constraints at user equipment, such as smartphones, tablets, and the like. Specifically, storing all applications and resources blindly to persistent cache 120 at user equipment 110 may run afoul of the memory limitations found in some wireless devices.

The application-aware browser 115 may be implemented to operate in accordance with protocols, such as HTML5, CSS 3.0, iOS, Android, Windows, and the like. The application-aware browser 115 may be implemented as a Cordova Apache-based application, although other types of applications may be implemented as well. In the case of Apache Cordova, user equipment 110 functions, such as the camera, location services, and the like, may be accessed using JavaScript.

The application-aware browser 115 may also be implemented to have various modes, such as a basic mode, a managed direct mode, and a managed optimized mode.

In a basic mode, web content may be viewed according to a user interface view, such as UIWebView. In the case of UIWebView, the UIWebView object may be attached to a browser 115 window, and this object may send a request, such as a HTTP GET, to load web content from server 160. The caching may be controlled by the UIWebView object, and the retrieved content, such as resources and the like, may be written to persistent cache 120. However, access to other plugins, device functions/interfaces, and the like may be restricted for the resources downloaded while in this basic mode for security reasons. However, resources accessed in other modes may not be so limited.

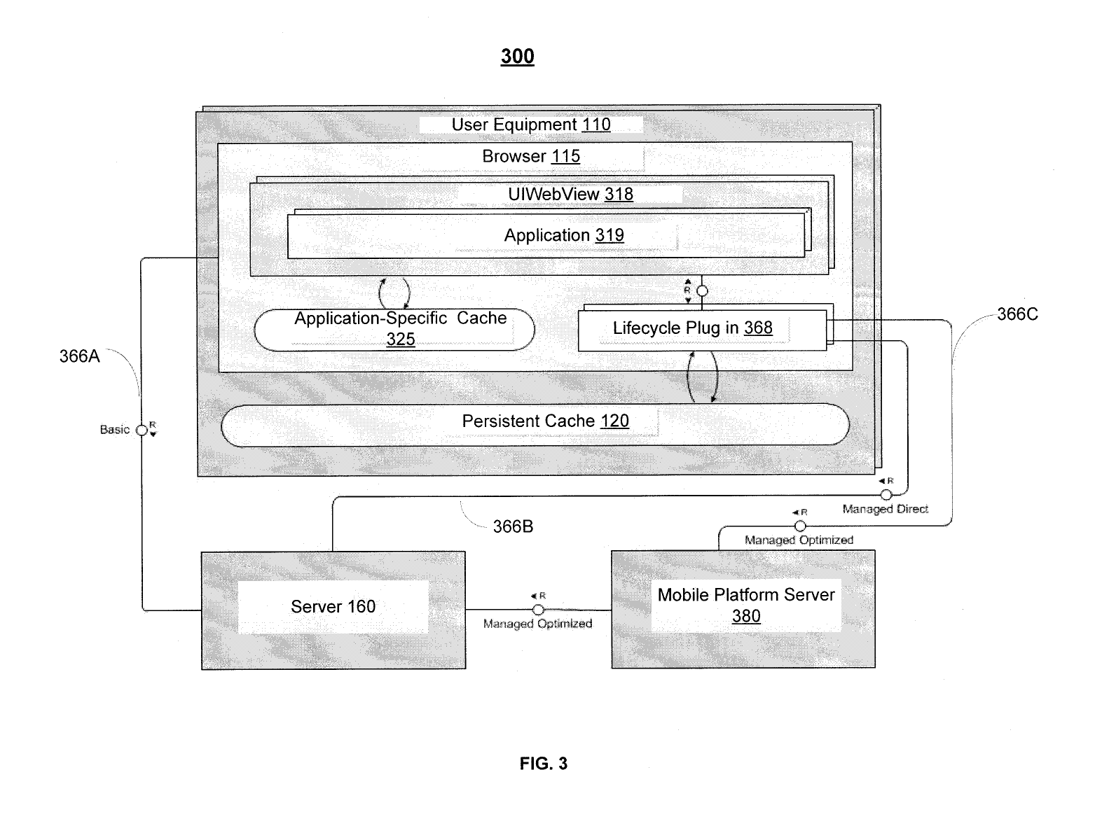

The managed mode refers generally to the managed direct mode and a managed optimized mode. In the managed mode, resources, such as specific web content at a given URL, may be designated to run in the managed mode. Moreover, a lifecycle plugin may control the getting, caching, and loading of the resources/web content at the identified URL. In managed direct, the lifecycle plugin may consume web content/resources at a URL directly from a web server, such as server 160. While in managed optimized mode, the lifecycle plugin consumes web content/resources at a URL via a proxy server (an example of which is described further below with respect to mobile platform server 380 at FIG. 3). The proxy may manage downloads from the server 160 to, for example, minimize the resource downloads and/or control the behavior of resources running in managed mode.

In some example implementations, application-aware browser 115 and server 160 may be implemented as part of a business system, such as an enterprise resource planning system, a sales planning system, a human resource management system, and the like. When this is the case, application-aware browser 115 may be configured to access and/or operate with specific servers at specific addresses (for example, server 160 at a certain address), which are part of the business system, although application-aware browser 115 and server 160 may be used in other frameworks and have access to other servers as well. For example, application-aware browser 115 may include a plugin or other form of code or script providing a business application accessible via application-aware browser 115. The content, resources, and the like of this plugin may be controlled so that when enabled, the content, resources, and the like of this plugin may be persistently cached to improve the startup time of the plugin.

The application-aware browser 115 may provide security features, such as support special security policies. Application-aware browser 115 may be configured to inspect web requests for valid content, authenticate applications, and require authentication to access certain features at the user equipment, such as a camera, geolocation information, and other device functions. For example, authentication may include a sign on, a password, and/or a digital certificate scheme. In some example implementations, the basic mode noted above may be enabled without authentication, but managed modes may require authentication. The configuration of the security features at browser 115 may be configured locally by a user of browser 115 or by a central controller, such as a central administrator.

The application-aware browser 115 may provide a full screen mode. For example, the user interface of the application-aware browser 115 may be configured to provide a full screen mode, when the user equipment 110 comprises a smartphone, a tablet, and other devices having a limited display region. The full screen mode may allow a page of web content/resource to be presented fully in a display, rather than as a partial screen of a display requiring thus scrolling to view the page. The browser 115 may be switched to a full screen mode by a dedicated JavaScript API or a meta-data tag in an HTML file associated with the presented page.

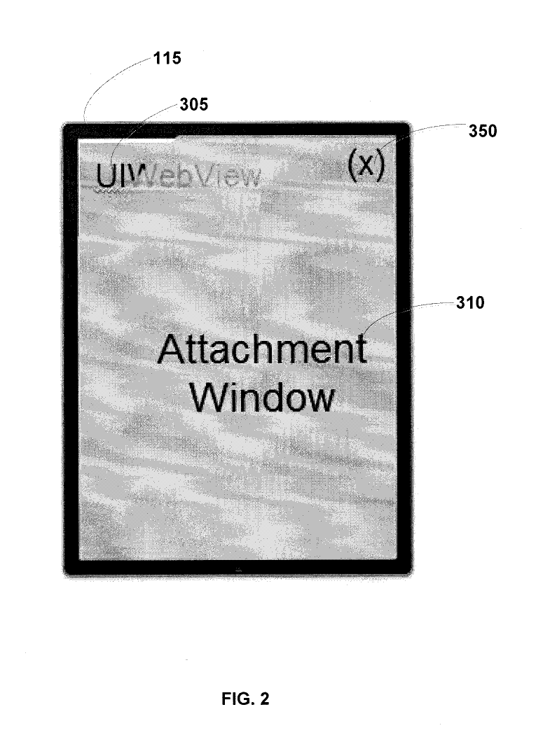

The application-aware browser 115 may provide an attachment and document viewer within a single window of the browser 115. This may maintain a single context for the end-user by remaining within the browser 115 application as shown in FIG. 2.

FIG. 2 shows a user interface view window 305 (labeled UIWebView) within browser 115. The window 305 further includes an attachment view window 310, where an attachment can be viewed. The attachment view window 310 of the attachment remains in the user interface of the browser 115, which allows for maintaining the context of the web content of 305, while the attachment view window 310 is visible or has not been terminated at 350. The attachment view window 310 may provide an attachment and document viewer configured to support a variety of file types, such as .pdf, .docx, .xlsx, .ppt, and the like. The attachment view window 310 may be launched in a full screen mode within browser 115 by selection or other action at the browser 115.

In some example implementations, browser 115 may be configured as a natively packaged application constructed using Apache Cordova and plugins, which renders and caches web content (for example, HTML5 and other types of content as well). This plugin may be configured to include native code including script, such as a JavaScript complement. The plugin may also adhere to the Cordova plugin specification, although other types of plugins may be used as well.

FIG. 3 depicts a system 300 including user equipment 110, which may couple wirelessly to server 160. The user equipment 110 may further include an application-aware browser 115.

The browser 115 may further include a UIWebView, which provides a user interface for resources and other content obtained from server 160. The UIWebView may, as noted, be configured to download applications and/or related resources from server 160 in a basic mode 366A. Moreover, the UIWebView may control whether applications and/or related content obtained from server 160 are stored to persistent cache 120.

In the example depicted at FIG. 3, the UIWebView object provides a user interface for application 319 and other resources/content from server 160. Application 319 (which may be implemented as a plugin) may access an application cache 325. The application cache 325 may store applications, related resources, and other content to enable accessing the application-specific cache 325 rather than server 160. This caching may enhance the startup speed as noted above. UIWebView object may be configured to control, in an application-specific way as disclosed herein, what content, resources, and the like are stored in cache 325. The application cache 325 may be implemented as an in-memory cache inside a browser process, so when a user closes the browser the content of the application cache 325 is lost. The persistent cache 120 may be implemented in a persistent way, such as in flash memory, so closing the session does not result in a loss of the data.

Browser 115 may include a lifecycle plugin 368 to control, in an application specific way, what applications, resources, and other content are stored in persistent cache 120. In this example, lifecycle plugin 368 controls storage to persistent cache 120 for application 319 to enable accessing the cached content directly, rather than via server 160 (which may enhance the startup speed as noted above).

The lifecycle plugin 368 may be used to manage, in an application-specific way as disclosed herein, storage of applications, resources, and other content to persistent cache 120. The lifecycle plugin 368 may be used when browser 115 is in the managed mode, while cache 325 may be used when in the direct, basic mode.

When browser 115 is in a managed optimized mode, lifecycle plugin 325 may access resources and other content at server 160 via a proxy, such as mobile platform server 380. Mobile platform server 380 may contain a list of up-to-date application specific data/resources and may provide a synchronization mechanism to a corresponding web server containing the current version of a web application. In case of data/resource changes on that web server 160, the mobile platform server 380 may update the list of up-to-date application-specific data/resources accordingly. However, only the changed data/resources need to be transferred to the client 300 as an optimized delta synchronization.

When browser 115 is in a managed direct mode, lifecycle plugin 325 may access resources and other content at server 160 without accessing mobile platform server 380.

The application-aware browser 115 may manage the download of content, such as resources, application plugins, and the like, using addresses, such as URLs. Specific URLs for certain content, resources, and the like may be designated to run in the managed mode, so loading of content can be performed using, for example, an HTTP GET. Moreover, lifecycle plugin 368 may control, for these URLs, the persistence caching to persistent cache 120. The lifecycle plugin 368 may consume content directly from the web server 160 and/or via the mobile platform server 380 (which may be used for optimization and additional administrative features). In addition, the lifecycle plugin 368 may provide interfaces for invalidating, deleting, and reloading the content from server 160 or 380.

The lifecycle plugin 368 may implement rules to optimize the resource download for end-user performance. These rules may include one or more of the following: a background download mode; an interactive download mode (where the end-user selects options for download, such as pause, continue, and the like); and a restricted download mode (for example, to restrict the download when there is a limited connectivity wireless link); and the like.

The application-aware browser 115 may manage and optimize changes to content or resources located at certain URLs. For example, lifecycle plugin 368 may download or otherwise access a manifest file (or other forms of metadata) for each web application. Specifically, lifecycle plugin 368 may assess changes to the manifest file at server 160 to be able to detect changes to a given application, such as application 319. Lifecycle plugin 368 may thus download a manifest file and then assess a timestamp associated with the manifest file. This timestamp may be used as a version number for the manifest file, so the lifecycle plugin 368 may determine whether the manifest file has been changed based on the manifest file's timestamp. For example, each time the manifest file is update to show a change to the content of an application, the timestamp may be updated. As such, lifecycle plugin 368 may compare the timestamp with a previously cached timestamp to determine whether an update has occurred. If a change has occurred, lifecycle plugin 368 may determine that an update to the cached 120 content is required. When this is the case, lifecycle plugin may initiate a download (or reload) from server 160 or 380 to update the persistent cache 120 with more recent content or other resources for application 319. The resource files to be cached 120 may be sent by server 160 or 380 in a compressed form.

The optimized managed mode may be configured to support a delta-mechanism. For example, mobile platform server 380 may take one or more snapshots of the manifest at server 160. When the plugin 368 discovers a change to the manifest file's version, the mobile platform server 380 may calculate the delta of the content/resources between the plugin's current version and the web server's 160 version. The delta of content/resources may be sent by server 160 to lifecycle plugin 368, where this delta can be cached 120 in an application-specific way as disclosed herein. The content/resource delta may be packed and compressed into a single delta file before being sent to browser 115, which updates the content/resources of the specific application. This optimized managed mode can be triggered when starting the application in a background mode or manually.

In managed mode, the application-aware browser 115 may be configured to have a whitelist of addresses, such as URLs of servers. Due to security concerns related to the privileged status that web content managed by the plugin 368 enjoys with respect to device application programming interfaces, a trusted method may be used for whitelisting the URLs to run in the managed mode. This may include an end-user onboarding step, and if a mobile platform server 380 (or proxy) is in use, the whitelist can be provided via a configuration service in a secure manner. The mobile platform server 380 may be implemented as a known server, which requires authentication for connecting clients, such as the application-aware browser. Once authenticated, the client may download configurations and settings which are deployed on that server. This is utilized in-part to protect the end user of the application-aware browser from malicious web application servers which might otherwise attempt to whitelist themselves and thus gain malicious access to the end-user's device application programming interfaces.

The application-aware browser 115 may manage the cache 325 to, for example, invalidate the contents of cache 325 and/or 120. For example, plugin 368 may handle the removal of resources from cache 325 and 120, such as web content that is no longer being used. Moreover, cache can be reset or cleared as well, in which case the browser 115 may return an initial state without uninstalling application 319.

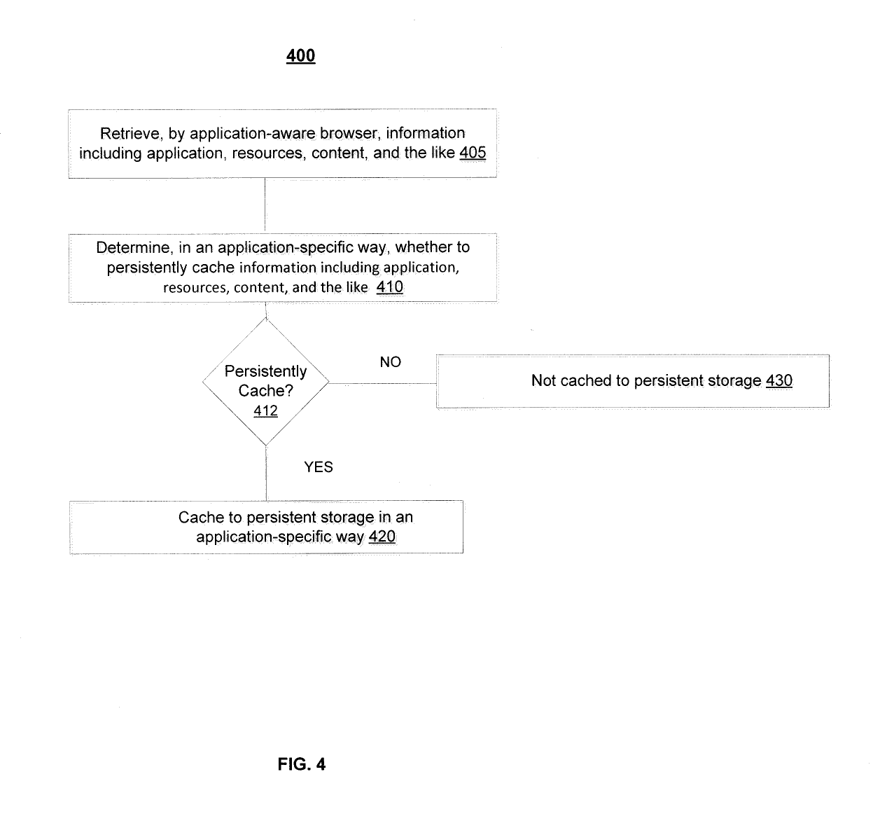

FIG. 4 depicts an example of a process 400 for application-aware browsing. The description of process 400 also refers to FIGS. 1 and 3.

At 405, a browser may access a web server to obtain an application and/or related resources and other information for that application. For example, browser 115 may retrieve from server 160 information, such as application 319 and/or related resources including content for application 319. In some example implementations, application 319 is a plugin application of a business system, although other types of applications may be used as well.

At 410, a determination is made, in an application-specific way, whether to persistently cache the application and/or related resources. For example, browser 115 may determine in an application-specific way whether to persistently store in persistent cache 120 the obtained application and/or related resources (including content). The browser 115 may make this determination based on metadata, such as metadata 166A-B, linked to obtained application 319, or the application 319 may signal browser 115 that persistent caching should be performed for application 319 and its resources. In some implementations, the browser 115 may include as metadata a whitelist of URLs representative of content that should be cached persistently to 120. However, if the metadata, URLs, or signaling do not indicate persistent caching, an application is not persistently cached at 120, but instead may be handled using normal memory management processes.

The application-aware browser 115 may, based on the determination at 410, cache to persistent storage in an application-specific way (yes at 412 and 420). For example, if metadata 166A-B, URLs, whitelist, the application itself, or any other mechanisms indicate that a certain application, such as application 319 should be cached in persistent cache 120, then browser 115 may store the application 319 including any related resources including content that is downloaded from server 160.

However, the application-aware browser 115 may, based on the determination at 410, decide not to cache to persistent storage in an application-specific way (no at 412 and 430). For example, if metadata 166A-B, URLs, whitelist, the application itself, or any other mechanism indicate that a certain application should not be cached in persistent cache 120, then browser 115 will not store in persistent cache 120 that application including any related resources including content that is downloaded from server 160, although that application and related resources may be stored in a non-persistent cache.

In some implementations of process 400, a user interface view, such as UIWebView object may control caching to persistent cache 120, as noted above with respect to the direct mode. In some implementations of process 400, a lifecycle plugin may control caching to persistent cache 120, as noted above with respect to the managed modes. In some implementations, when an application 319 is initially granted access to persistent cache 120, the access may be under the direct mode, but as the application or associated user is authenticated or gains additional trust managed modes may be implemented.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although some of the examples described herein refer to a wireless user equipment and/or a mobile user equipment, the user equipment may have wired connections as well and/or be stationary as well.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other implementations may be within the scope of the following claims.

What is claimed:

1. A computer-readable medium containing instructions to configure at least one processor to cause operations comprising:
retrieving, by a browser, content of a resource;
determining, based on an identity of the resource, whether to store the content in a persistent cache; and
storing the content in the persistent cache, when the identity indicates storage to persistent cache is enabled for the content of the resource.

2. The computer-readable medium of claim 1 further comprising:
storing the content in a non-persistent cache, when the identity indicates storage to persistent cache is not enabled for the content of the resource.

3. The computer-readable medium of claim 1, wherein the browser includes a plugin configured to perform at least the determining and the storing.

4. The computer-readable medium of claim 2, wherein the plugin includes script configured in accordance Apache Cordova.

5. The computer-readable medium of claim 2, wherein the plugin is native to the browser.

6. The computer-readable medium of claim 1, wherein the resource includes at least one of the following: a plugin, an application, a hypertext markup language file, a cascading style sheet, a script, a JavaScript, a JavaScript Object Notation, and an image.

7. The computer-readable medium of claim 1, wherein the determining further comprises:
accessing metadata indicative of whether storage to persistent cache is enabled for the content of the resource, wherein the metadata includes at least one of the identity of the resource, an address of the resource, and a uniform resource locator of the resource, and wherein the storing further comprises:
storing, based on the accessed metadata, the content in the persistent cache, when the metadata indicates storage to persistent cache is enabled for the content.

8. The computer-readable medium of claim 7, wherein the metadata includes a list of one or more resources.

9. The computer-readable medium of claim 2, wherein the determining further comprises:
receiving, from at least one of the plugin and a web server, an indication that storage to persistent cache is enabled for the content; and wherein the storing further comprises:
storing, based on the received indication, the content in the persistent cache, when the received indication indicates storage to persistent cache is enabled for the content.

10. A method comprising:
retrieving, by a browser, content of a resource;
determining, based on an identity of the resource, whether to store the content in a persistent cache; and
storing the content in the persistent cache, when the identity indicates storage to persistent cache is enabled for the content of the resource.

11. The method of claim 10 further comprising:
storing the content in a non-persistent cache, when the identity indicates storage to persistent cache is not enabled for content of the resource.

12. The method of claim 10, wherein the browser includes a plugin configured to perform at least the determining and the storing.

13. The method of claim 11, wherein the plugin includes script configured in accordance Apache Cordova.

14. The method of claim 11, wherein the plugin is native to the browser.

15. The method of claim 10, wherein the resource includes at least one of the following: a plugin, an application, a hypertext markup language file, a cascading style sheet, a script, a JavaScript, a JavaScript Object Notation, and an image.

16. The method of claim 10, wherein the determining further comprises:
accessing metadata indicative of whether storage to persistent cache is enabled for the content of the resource, wherein the metadata includes at least one of the identity of the resource, an address of the resource, and a uniform resource locator of the resource, and wherein the storing further comprises:
storing, based on the accessed metadata, the content in the persistent cache, when the metadata indicates storage to persistent cache is enabled for the content.

17. The method of claim 16, wherein the metadata includes a list of one or more resources.

18. The method of claim 11, wherein the determining further comprises:
receiving, from at least one of the plugin and a web server, an indication that storage to persistent cache is enabled for the content; and wherein the storing further comprises:
storing, based on the received indication, the content in the persistent cache, when the received indication indicates storage to persistent cache is enabled for the content.

19. A system comprising:
at least one processor; and
at least one memory including computer program code which when executed causes operations comprising:
retrieving, by a browser, content of a resource;
determining, based on an identity of the resource, whether to store the content in a persistent cache; and
storing the content in the persistent cache, when the identity indicates storage to persistent cache is enabled for the content of the resource.
